(19) United States
(12) Patent Application Publication
(10) Pub. No.: US 2006/0087737 A1
(43) Pub. Date: Apr. 27, 2006

(54) Optical system using diffraction optical element

(75) Inventors: Yun Seok Choi, Kyungki-do (KR); Ho Seop Jeong, Kyungki-do (KR); Chon Su Kyong, Seoul (KR); Dong Ik Shin, Kyungki-do (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Kyungki-do (KR)

(21) Appl. No.: 11/183,964

(22) Filed: Jul. 19, 2005

(30) Foreign Application Priority Data
Oct. 25, 2004 (KR) 10-2004-85315

(51) Int. Cl. G02B 5/18; G02B 27/44

(52) U.S. Cl. 359/566; 359/569

(57) ABSTRACT

There is provided an optical system using diffraction optical elements (DOEs) for improving chromatic aberration correction performance by arranging two DOEs between planes adjacent to a lens having plus refractive power and a lens having minus refractive power. The optical system has an aperture stop for controlling light amount, a first lens group, a second lens group, and a third lens group, which are sequentially arranged from an object side. The first lens group includes a first lens having plus refractive power and a second lens having minus refractive power arranged sequentially from the object side. The second or third lens group has a lens where at least one refraction surface is aspherical. In the optical system using DOEs (diffraction optical elements), a first DOE is joined to an image side of the first lens and a second DOE is joined to an object side of the second lens in correspondence to the first diffraction optical element.

### RELATED APPLICATION

The present application is based on, and claims priority from, Korean Application Number 2004-0085315, filed Oct. 25, 2004, the disclosure of which is hereby incorporated by reference herein in its entirety.

### BACKGROUND OF THE INVENTION

1. Field of the Invention

The present invention relates to an optical system using two diffraction optical elements (DOE), and more particularly, to an optical system using DOEs, for improving chromatic aberration correction performance, by arranging two DOEs between planes adjacent to a lens having plus refractive power and a lens having minus refractive power.

2. Description of the Related Art

Generally, there exist several aberrations in an optical system. Among them, a spherical aberration, a comatic aberration, astigmatism, a curve on an image plane, and a distortion aberration are due to the fact that a lens is spherical and a chromatic aberration is due to the fact that a lens shows different indexes of refraction depending on a wavelength of light.

That is, since an index of refraction of light is a function of a wavelength, rays that have passed through a lens are focused at different positions, sequentially in an order of a blue ray whose wavelength is short, a green ray which has a wavelength between a blue ray and a red ray, and a red ray whose wavelength is long, whereby a chromatic aberration is generated.

To solve the chromatic aberration problem, a doublet lens in which a convex lens of a crown series having a big abbe number and a small index of refraction and a concave lens of a flint series having a small abbe number and a big index of refraction are combined, has been used.

However, in case of using the doublet lens, it is difficult to construct an optical system in a compact size and a thickness of a lens in a central part gets thick for correcting a curve on an image plane in a sagital, whereby a total length of an optical system is increased. Thus, it is difficult to manufacture the optical system having a small size and a slim profile and there exist limitations in reducing a weight of the optical system.

In the meantime, a method for correcting a chromatic aberration of an optical system by installing a diffraction optical element for performing diffraction on part of the optical system is known. The above method uses physical phenomenon that the chromatic aberrations for a ray of a reference wavelength are represented in a reverse direction on a refraction plane and a diffraction plane, respectively, in an optical system.

However, in case of using one DOE as described above, it is difficult to achieve a diffraction efficiency of 100% over the whole visible ray region. Actually, in a region where diffraction efficiency is not high, an effect is represented as if a ray did not exist substantially, so that an image is not formed.

To improve such a problem, the Japanese Patent Publication No.2001-324610 (published as of Nov. 22, 2001) suggests a stacked-type diffraction optical element capable of achieving light's diffraction efficiency of 100% over the whole visible ray region by combining two single-layer type DOE.

Here, each DOE is formed by optical material having different abbe number and a shape and a matter of the DOE are optimized so that diffraction efficiency may approach 100%, and two single-layer type DOEs are overlapped. Thus, a composite characteristics where characteristics of each single-layer type DOE are combined, is represented.

However, the single-layer type DOE is manufactured flat and provided between lenses. Therefore, if the single-layer type DOE is applied to an optical system, a total length of the optical system is increased, which is disadvantageous in viewpoint of a small size and a slim profile.

Therefore, a demand for an optical system that can improve correction performance for a chromatic aberration and can be easily manufactured in a small size, is increasing.

### SUMMARY OF THE INVENTION

Accordingly, the present invention is directed to an optical system using diffraction optical elements (DOE) that substantially obviates one or more problems due to limitations and disadvantages of the related art.

An object of the present invention is to provide an optical system using DOEs, capable of improving a chromatic aberration correction performance by arranging two DOEs between a lens having plus refractive power and a lens having minus refractive power, in which the DOE can be easily manufactured.

Another object of the present invention is to provide an optical system using DOEs of a subminiature, ultra slim profile and a high performance.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an optical system using DOEs (diffraction optical elements) comprises an aperture stop for controlling light amount; a first lens group, a second lens group, and a third lens group arranged sequentially from an object side, the first lens group including a first lens having plus refractive power and a second lens having minus refractive power arranged sequentially from the object side, and the second and the third lens groups having a lens, at least one refraction surface of which is aspherical; a first DOE joined to an image side of the first lens; and a second DOE joined to an object side of the second lens in correspondence to the first DOE.

Preferably, the first DOE has dentations of a vertical symmetry on its cross section of an optical axis and the dentations are so configured as to form a plurality of concentric circles around the optical axis. A shape of the second DOE is so formed as to be engaged with that of the first DOE, and the concentric circles get small in their pitch when they are positioned on outer sides of the first and the second DOEs.

In addition, the first and the second DOEs are formed with optical material having the same abbe number and the optical material may be polymethyl methacrylate (PMMA).

Further, a first DOE's thickness on an optical axis may be different from a second DOE's thickness on an optical axis and it is desirable that the first DOE's thickness on the optical axis is smaller.

Still further, it is desirable that an interval between the first and the second DOEs is smaller than the thickness of the first DOE so that diffraction flare light generated from the first DOE may be incident to the second DOE before the diffraction flare light is diffused.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a lens construction of an optical system using a diffraction optical element (DOE) according to a first embodiment of the present invention;

FIG. 2 is a graph explaining aberrations of the first embodiment shown in FIG. 1, in which (a), (b), and (c) represent a spherical aberration, astigmatism, and distortion, respectively;

FIGS. 3A and 3B are graphs illustrating MTF characteristics of the first embodiment shown in FIG. 1;

FIG. 4 is a view explaining a lens construction of an optical system using a diffraction optical element (DOE) according to a second embodiment of the present invention;

FIG. 5 is a graph explaining aberrations of the second embodiment shown in FIG. 4, in which (a), (b), and (c) represent a spherical aberration, astigmatism, and distortion, respectively;

FIGS. 6A and 6B are graphs illustrating MTF characteristics of the second embodiment shown in FIG. 4;

FIG. 7 is a view explaining a lens construction of an optical system using a diffraction optical element (DOE) according to a third embodiment of the present invention;

FIG. 8 is a graph explaining aberrations of the third embodiment shown in FIG. 7, in which (a), (b), and (c) represent a spherical aberration, astigmatism, and distortion, respectively;

FIGS. 9A and 9B are graphs illustrating MTF characteristics of the third embodiment shown in FIG. 7;

FIG. 10 is a view illustrating a DOE according to the present invention, in which (a) and (b) represent a cross-sectional view and a plane view, respectively;

FIG. 11 is a view explaining a lens construction of a first example compared with the first embodiment of the present invention;

FIG. 12 is a graph explaining aberrations of the first example shown in FIG. 11, in which (a), (b), and (c) represent a spherical aberration, astigmatism, and distortion, respectively;

FIGS. 13A and 13B are graphs illustrating MTF characteristics of the first example shown in FIG. 11;

FIG. 14 is a view explaining a lens construction of a second example compared with the second embodiment of the present invention;

FIG. 15 is a graph explaining aberrations of the second example shown in FIG. 14, in which (a), (b), and (c) represent a spherical aberration, astigmatism, and distortion, respectively; and

FIGS. 16A and 16B are graphs illustrating MTF characteristics of the second example shown in FIG. 14.

### DETAILED DESCRIPTION OF THE INVENTION

Reference will now be made in detail to the preferred embodiments of the present invention, examples of which are illustrated in the accompanying drawings.

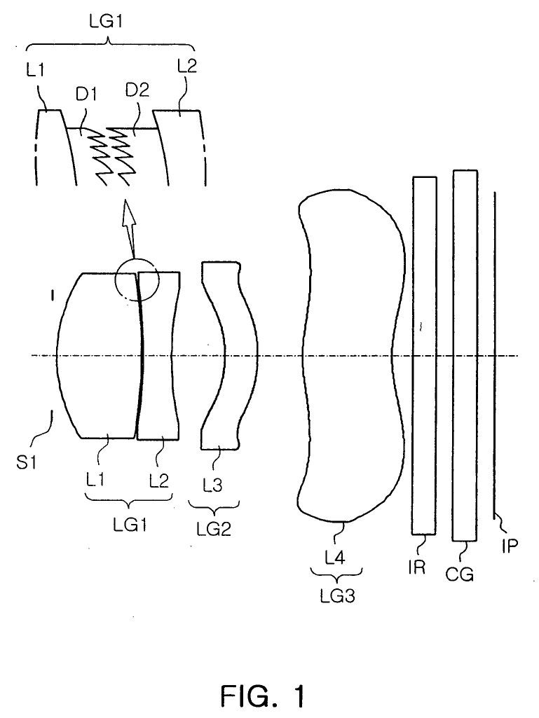

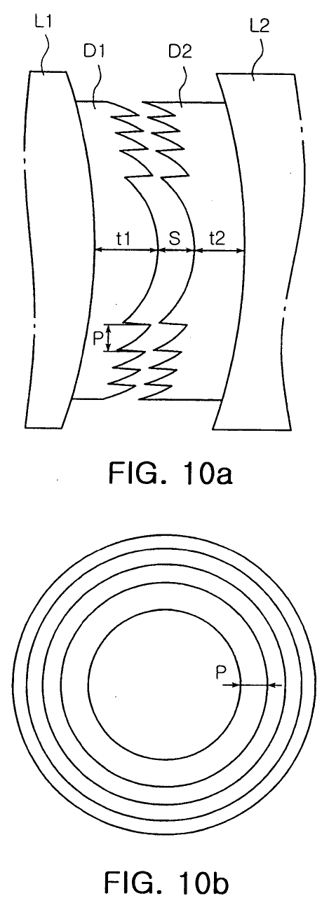

FIG. 1 is a view illustrating a lens construction of an optical system using a diffraction lattice according to a first embodiment of the present invention, and FIGS. 10A and 10B are a cross-sectional view and a plan view illustrating a DOE according to the present invention, respectively.

As illustrated in FIG. 1, an optical system using the diffraction lattice of the present invention include: a first lens L1 having plus refractive power; a second lens L2 having minus refractive power; a first diffraction optical element (DOE) D1 joined to the first lens L1; and a second DOE D2 joined to the second lens L2.

The first and the second lenses L1 and L2 correct a chromatic aberration and have a function similar to the conventional doublet lens.

As illustrated in an enlarged part of FIGS. 1 and 10, the first DOE D1 is joined to an image side of the first lens L1 and the second DOE D2 is joined to an object side of the second lens L2.

Diffraction is generated in the DOEs D1 and D2 by interference between an object source and a reference source.

A shape and a thickness of these DOEs D1 and D2, and an interval between the DOEs can be optimized by setting a phase amount by the DOEs D1 and D2 with consideration of diffraction efficiency.

That is, the first lens L1, the first DOE D1, the second DOE D2, and the second lens L2 are formed so that characteristics of theses elements may be properly combined and a chromatic aberration can be improved and performance of an optical system can be enhanced.

At this point, it is desirable that a shape and a matter of the first and the second DOEs D1 and D2 are determined so that diffraction efficiency may approach 100% over the whole visible ray region.

A chromatic aberration has been corrected using the first and the second lenses L1 and L2 in the related art, but the present invention can obtain an optical system capable of improving even more a chromatic aberration performance and remarkably improving diffraction efficiency over the whole visible region compared with a case of using a single DOE, by introducing the first and the second DOEs D1 and D2.

As illustrated in FIG. 10A, the first DOE D1 has dentations of a vertical symmetry on its cross section of an optical axis and, as illustrated in FIG. 10B, the dentations are so configured as to form a plurality of concentric circles around the optical axis. The shape of the second DOE D2 is so formed as to be engaged with that of the first DOE D1.

At this point, the concentric circles get small in their pitch P when they are positioned on outer sides of the first and the second DOEs.

Generally, less than twenty-five concentric circles are required for a DOE. However, it is preferable to provide two to ten concentric circles.

In the case of one concentric circle, no diffraction effect is obtained and if the number of concentric circles is increased, flare phenomenon due to diffraction might be generated and it is difficult to process a DOE.

Therefore, it is desirable in viewpoint of convenience in processing a DOE that less than ten concentric circles is applied as is done in the embodiment described below as far as an optical performance of an optical system is sufficiently realized.

Four concentric circles are illustrated in FIG. 4 and FIGS. 1 through 9 illustrate characteristics of an optical system using four concentric circles.

In the meantime, the present invention has an advantage of sufficiently realizing required optical characteristics as is done in the embodiment described below even in case of forming the first and the second DOEs D1 and D2 using optical material of the same abbe number, not the different abbe number, by joining the first and the second DOEs D1 and D2 to the first and the second lenses L1 and L2 performing a function similar to the doublet.

At this point, it is desirable that the optical material is prepared by PMMA so that optical characteristics of the DOE may be sufficiently realized.

As illustrated in FIG. 10, the first DOE D1's thickness t1 on an optical axis may be different from the second DOE D2's thickness t2 on an optical axis, which is determined by optimizing an optical system.

At this point, when the first DOE D1's thickness t1 on the optical axis is smaller than the second DOE D2's thickness t2 on the optical axis, the optical performance is more excellent.

In the meantime, it is desirable that an interval S between the first and the second DOEs D1 and D2 is smaller than the thickness t1 of the first DOE D1 so that diffraction flare light generated from the first DOE D1 may be incident to the second DOE D2 before the diffraction flare light is diffused.

Unlike the arrangement in FIG. 1, it is also possible to position the first lens L1 having plus refractive power behind the second lens L2 having minus refractive power and arrange the first and the second DOEs D1 and D2 between those lenses L1 and L2.

More specifically, as illustrated in FIGS. 1 through 9 and the first through the third embodiments which will be described below, the present invention can be applied to an optically system, which includes, sequentially from an object side: an aperture stop S1; a first lens group LG1; a second lens group LG2; and a third lens group LG3, the first lens group LG1 including, sequentially from the object side, a first lens L1 having plus refractive power and a second lens L2 having minus refractive power, the second lens group LG2 or the third lens group LG3 has a lens including at least one refraction surface that is aspherical.

At this point, the first DOE D1 is joined to an image side of the first lens L1 and the second DOE D2 is joined to an object side of the second lens L2 in correspondence to the first DOE D1, and diffraction efficiency can be increased and a chromatic aberration correction performance can be enhanced by the DOEs D1 and D2.

The first and the second DOEs D1 and D2 provided here have the same construction as described above.

In the meantime, an infrared (IR) filter and a cover glass (CG) are installed in a rear side of the third lens group LG3 in correspondence to an optical low-pass filter (OLPF), a color filter, or a face plate, but the IR filter and the CG may be replaced by other filter, and do not have an influence, in principle, on an optical property of the present invention.

Further, a solid image pickup element (photoelectric transformation element) of a high resolution consisting of a charge coupled device (CCD) sensor or a complementary metal oxide semiconductor (CMOS) sensor and having an image plane (IP) (photosensitive plane) 12 for receiving an image formed by a lens is arranged in a rear side of the CG.

Numerical embodiment of the present invention will be now described in detail in the following.

As described above, in the following first through third embodiments and the following first and second comparison examples, an optical system has an aperture stop S1 arranged closest to an object side, and includes, sequentially from the object side: a first lens group LG1 having a first and a second lenses L1 and L2; a second lens group LG2 having a third lens L3; and a third lens group LG3 having a fourth lens L4, in which an IR filter and a CG are provided between the third lens group LG 3 and an IP.

An aspherical surface used in each of the following embodiments and the following comparison examples is obtained by the following known equation 1 and E and a number following the E used in a conic constant K and aspherical coefficients A, B, C, and D represent a 10's power. For example, E21 and E-02 represent 10²¹ and 10⁻², respectively.

$$Z = ( {Y}^{2} / r ) [ 1 + \sqrt{1 - ( 1 + K ) {( Y / r )}^{2}} ] + {AY}^{4} + {BY}^{6} + {CY}^{8} + {DY}^{10}$$

Z: distance toward an optical axis from a vertex of a lens

Y: distance toward a direction perpendicular to an optical axis

r: radius of curvature on a vertex of a lens

K: conic constant

A,B,C, and D: aspherical coefficients

### First Embodiment

The following table 1 represents numerical examples according to a first embodiment of the present invention.

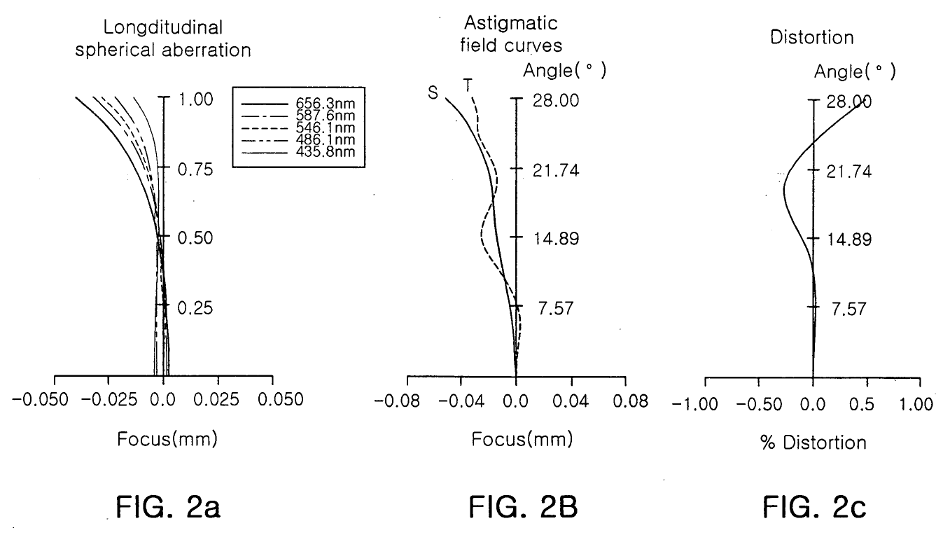

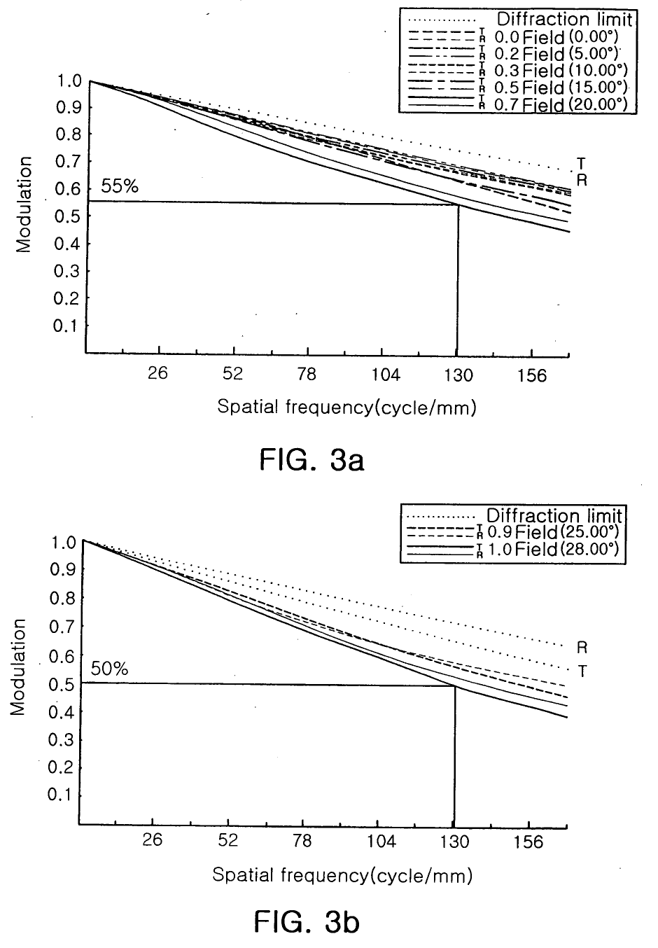

FIG. 1 is a view illustrating a lens construction of an optical system using a diffraction lattice according to a first embodiment of the present invention, FIGS. 2A through 2C are graphs explaining aberrations of an optical system shown in table 1 and FIG. 1, and FIG. 3 is a graph illustrating MTF characteristics of the first embodiment.

A thickness, a size, and a shape of a lens have been exaggerated more or less in the following lens construction, and shapes of the spherical and the aspherical surfaces suggested by the drawings have been suggested for an example purpose only and not limited to those shapes.

Further, in the following graph illustrating astigmatism, “S”, “T” represent sagital, tangential, respectively, and in the graph illustrating the modulation transfer function (MTF) characteristics, “T” represents tangential MTF variations of a special frequency per millimeter, and “R” represents radial MTF variations of a spatial frequency per millimeter.

Here, the MTF depends on a spatial frequency of a cycle per millimeter and is defined by the following equation 2 between a maximum intensity and a minimum intensity of light.

$$MTF = \frac{Max - Min}{Max + Min} \qquad Equation 2$$

That is, if the MTF is one, a resolution is most ideal and a resolution falls down as an MTF is reduced.

In the first embodiment, F number is 2.8, an incident angle is 20° or less, and an image height is 4 mm.

TABLE 1

| | | Thickness | | | |
|---|---|---|---|---|---|
| | Radius of | or | Index of | Abbe | |
| | curvature | distance | refraction | number | |
| Plane No. | (R) | (t) | (Nd) | (vd) | Remark |
| S1 | ∞ | 0.1000 | — | — | Aperture |
| | | | | | stop |
| 1 | 4.0522 | 1.8000 | 1.8042 | 46.5 | 1st lens |
| | | | | | group |
| 2 | −13.1538 | 0.0100 | 1.49 | 58 | 1st DOE |
| 3 | −13.1538 | 0.0020 | — | — | |
| (diffraction | | | | | |
| plane) | | | | | |
| 4 | −13.1538 | 0.0150 | 1.49 | 58 | 2nd DOE |
| (diffraction | | | | | |
| plane) | | | | | |
| 5 | −13.1538 | 0.6000 | 1.8052 | 25.5 | |
| 6 | 8.3620 | 1.1446 | — | — | |
| *7 | −3.1028 | 0.7000 | 1.53 | 56 | 2nd lens |
| | | | | | group |
| *8 | −3.8134 | 0.9500 | — | — | |
| *9 | 4.1508 | 1.9000 | 1.53 | 56 | 3rd lens |
| | | | | | group |
| *10 | 3.6953 | 0.4456 | — | — | |
| 11 | ∞ | 0.5000 | 1.5168 | 64.2 | IR |
| | | | | | filter |
| 12 | ∞ | 0.3815 | — | — | |
| 13 | ∞ | 0.5000 | 1.5168 | 64.2 | Cover |
| | | | | | glass |
| 14 | ∞ | 0.3815 | — | — | |
| 15 | ∞ | 0.0000 | — | — | Image |
| | | | | | plane |

In table 1, * represents an aspherical surface and aspherical coefficients by the equation 1 are given as follows. Here, a seventh surface (object side of the third lens), an eighth surface (image side of the third lens), a ninth surface (object side of the fourth lens), and a tenth surface (image side of the fourth lens) are aspherical.

Coefficients of the seventh aspherical surface are given by:

K: −0.176405

A: −0.159766E-01

B: 0.298267E-02

C: 0.311938E-02

D: −0.561250E-03

Coefficients of the eighth aspherical surface are given by:

K: 1.827367

A: −0.241994E-01

B: 0.917725E-02

C: 0.657321E-03

D: −0.740500E-04

Coefficients of the ninth aspherical surface are given by:

K: −5.766732

A: −0.266805E-01

B: 0.448193E-02

C: −0.390766E-03

D: 0.127579E-04

Coefficients of the tenth aspherical surface are given by:

K: −5.917002

A: −0.127131E-01

B: 0.921263E-03

C: −0.453984E-04

D: −0.434912E-06

In the first embodiment, a distance from the aperture stop S1 to an IP of an optical system (referred to as “TL” hereinafter) is 9.430 mm and a distortion is less than 0.5% as illustrated in FIG. 2C.

Further, the MTF characteristics of more than 50% can be obtained under 130 cycle/mm as illustrated in FIG. 3.

### FIRST COMPARISON EXAMPLE

Following table 2 represents a first comparison example in connection with the first embodiment of the present invention.

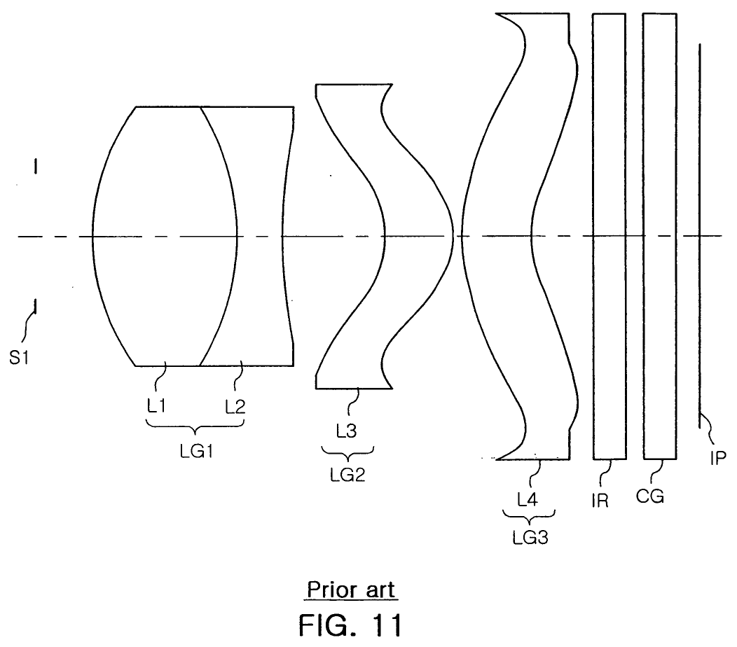

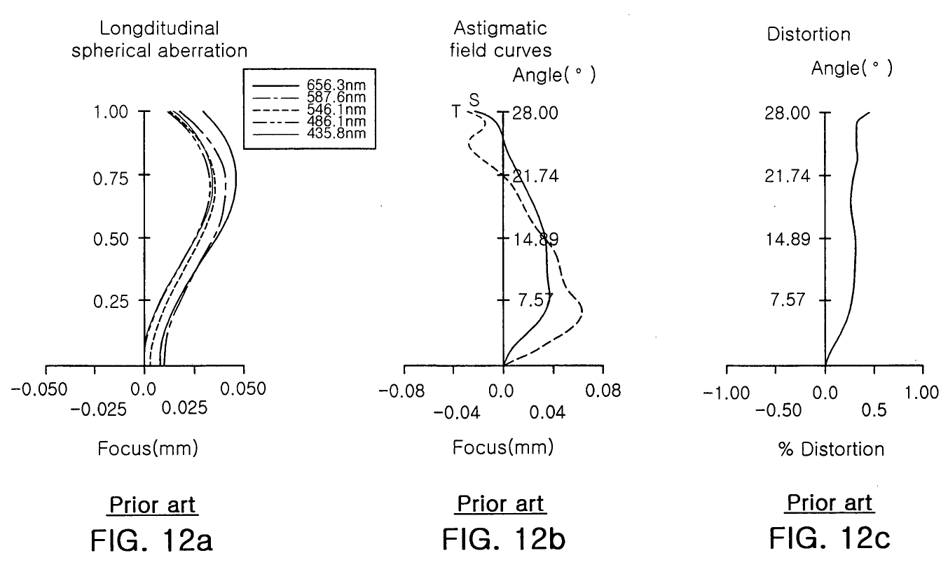

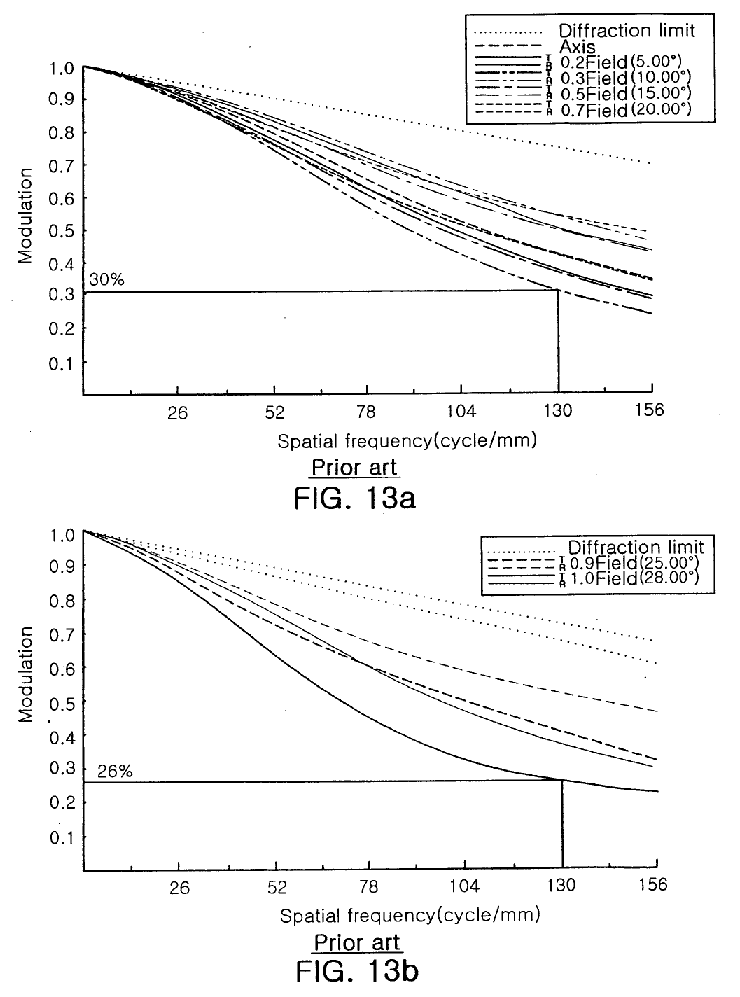

FIG. 11 is a view illustrating a lens construction of an optical system using a diffraction lattice according to a first comparison example, FIGS. 12A through 12C are graphs explaining aberrations of an optical system shown in table 2 and FIG. 11, and FIG. 13 is a graph illustrating MTF chacteristics of the first comparison example.

For comparison with the first embodiment, F number is 2.8, an incident angle is 20° or less, and an image height is 4 mm in the first comparison example.

TABLE 2

| | | Thickness | | | |
|---|---|---|---|---|---|
| | Radius of | or | Index of | Abbe | |
| | curvature | distance | refraction | number | |
| Plane No. | (R) | (t) | (Nd) | (vd) | Remark |
| S1 | ∞ | 1.0508 | — | — | Aperture |
| | | | | | stop |
| 1 | 5.2511 | 2.5000 | 1.8042 | 46.5 | 1st lens |
| | | | | | group |
| 2 | −5.8262 | 0.8000 | 1.8052 | 25.5 | |
| 3 | 12.2079 | 1.8000 | — | — | |
| *4 | −2.4213 | 1.2000 | 1.53 | 56 | 2nd lens |
| | | | | | group |
| *5 | −1.7363 | 0.1500 | — | — | |
| *6 | 4.1456 | 1.2000 | 1.53 | 56 | 3rd lens |
| | | | | | group |
| *7 | 2.1302 | 1.1000 | — | — | |
| 8 | ∞ | 0.5500 | 1.5168 | 64.2 | IR |
| | | | | | filter |
| 9 | ∞ | 0.3000 | — | — | |
| 10 | ∞ | 0.5500 | 1.5168 | 64.2 | Cover |
| | | | | | glass |
| 11 | ∞ | 0.3000 | — | — | |
| 12 | ∞ | 0.0000 | — | — | Image |
| | | | | | Plane |

In table 2, * represents an aspherical surface and aspherical coefficients by the equation 1 are given as follows. Here, a fourth surface (object side of the third lens), a fifth surface (image side of the third lens), a sixth surface (object side of the fourth lens), and a seventh surface (image side of the fourth lens) are aspherical.

Coefficients of the fourth aspherical surface are given by:

K: −0.738800

A: −0.138697E-01

B: 0.506085E-02

C: −0.131612E-03

D: 0.155949E-04

Coefficients of the fifth aspherical surface are given by:

K: −0.921826

A: 0.788643E-02

B: 0.821847E-04

C: 0.350679E-03

D: −0.232394E-04

Coefficients of the sixth aspherical surface are given by:

K: −20.778681

A: 0.673113E-02

B: −0.577860E-03

C: 0.317146E-04

D: −0.987329E-06

Coefficients of the seventh aspherical surface are given by:

K: −6.271202

A: −0.629313E-02

B: 0.762312E-03

C: −0.448126E-04

D: 0.660156E-06

In the first comparison example, a TL of an optical system is 11.660 mm, a distortion is less than 0.5% as illustrated in FIG. 12C, and a resolution under 130 cycle/mm is more than 26% as illustrated in FIG. 3.

Comparison of the first embodiment with the first comparison example shows that the first embodiment has the smaller TL and thus small sizing and slim profiling of an optical system are possible and also has a far better resolution on the MTF curve.

### Second Embodiment

The following table 3 represents numerical examples according to a second embodiment of the present invention.

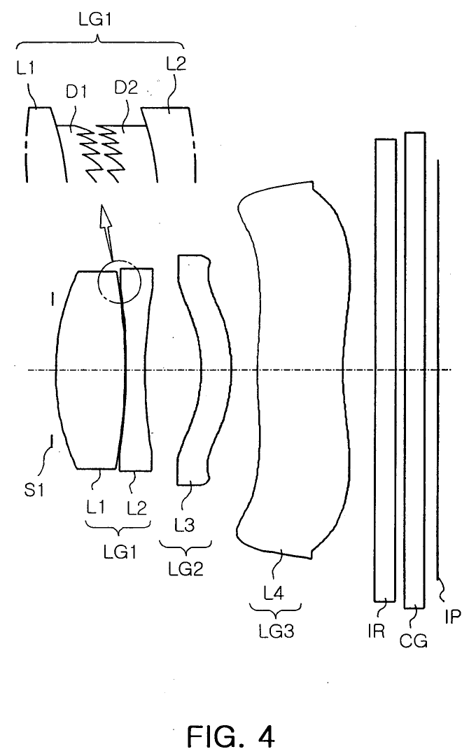

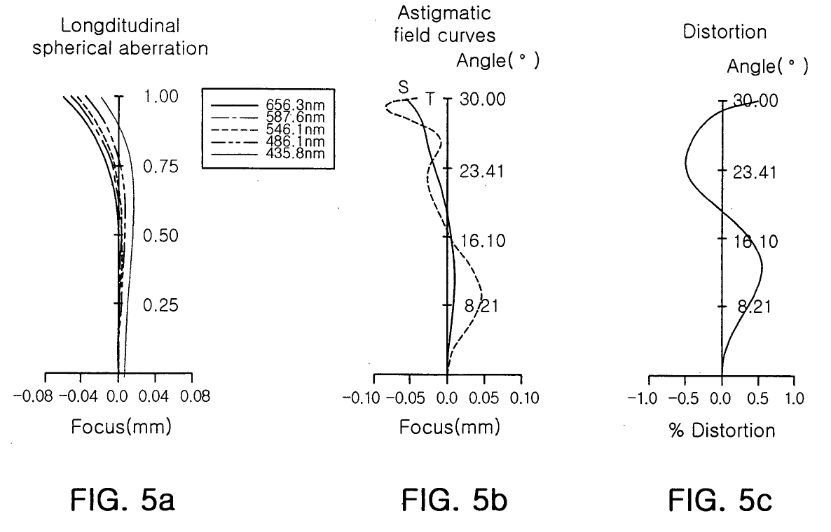

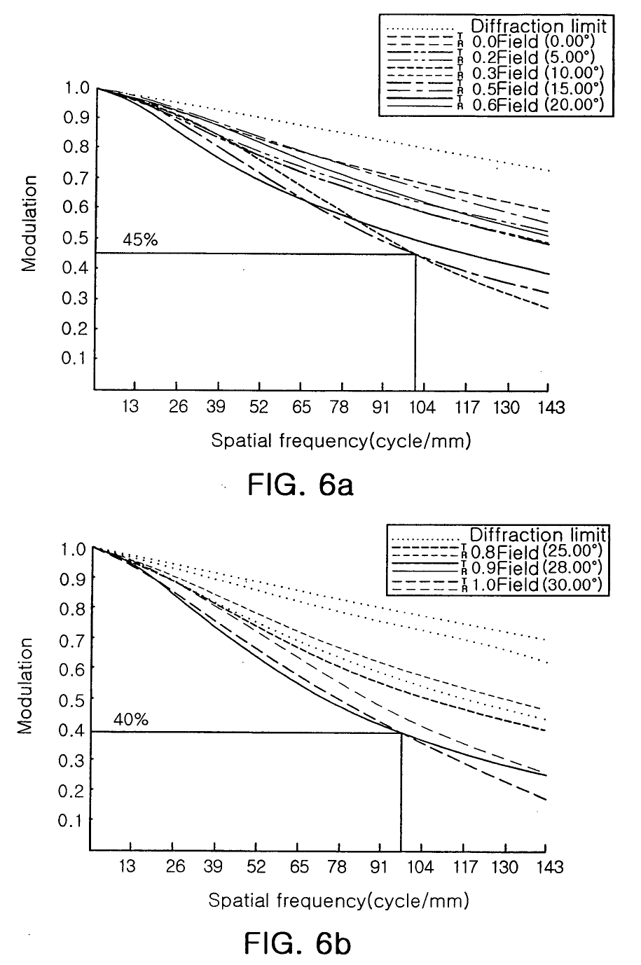

FIG. 4 is a view illustrating a lens construction of an optical system using a diffraction lattice according to a second embodiment of the present invention, FIGS. 5A through 5C are graphs explaining aberrations of an optical system shown in table 3 and FIG. 4, and FIG. 6 is a graph illustrating MTF characteristics of the second embodiment.

In the second embodiment, F number is 2.8, an incident angle is 20° or less, and an image height is 4.4 mm.

TABLE 3

| | | Thickness | | | |
|---|---|---|---|---|---|
| | Radius of | or | Index of | Abbe | |
| | curvature | distance | refraction | number | |
| Plane No. | (R) | (t) | (Nd) | (vd) | Remark |
| S1 | ∞ | 0.1000 | — | — | Aperture |
| | | | | | stop |
| 1 | 4.1681 | 1.7432 | 1.8042 | 46.5 | 1st lens |
| | | | | | group |
| 2 | −9.9176 | 0.0100 | 1.49 | 58 | 1st DOE |
| 3 | −9.9176 | 0.0020 | — | — | |
| (diffraction | | | | | |
| plane) | | | | | |
| 4 | −9.9176 | 0.0150 | 1.49 | 58 | 2nd DOE |
| (diffraction | | | | | |
| plane) | | | | | |
| 5 | −9.9176 | 0.4712 | 1.8052 | 25.5 | |
| 6 | 9.0028 | 1.3902 | — | — | |
| *7 | −2.8549 | 0.7593 | 1.53 | 56 | 2nd lens |
| | | | | | group |
| *8 | −3.3501 | 0.6718 | — | — | |
| *9 | 5.2399 | 2.1900 | 1.53 | 56 | 3rd lens |
| | | | | | group |
| *10 | 4.8254 | 0.8411 | — | — | |
| 11 | ∞ | 0.4994 | 1.5168 | 64.2 | IR |
| | | | | | filter |
| 12 | ∞ | 0.2535 | — | — | |
| 13 | ∞ | 0.4994 | 1.5168 | 64.2 | Cover |
| | | | | | glass |
| 14 | ∞ | 0.3043 | — | — | |
| 15 | ∞ | 0.0000 | — | — | Image |
| | | | | | plane |

In table 3, * represents an aspherical surface and aspherical coefficients by the equation 1 are given as follows. Here, a seventh surface (object side of the third lens), an eighth surface (image side of the third lens), a ninth surface (object side of the fourth lens), and a tenth surface (image side of the fourth lens) are aspherical.

Coefficients of the seventh aspherical surface are given by:

K: −0.191571

A: −0.170882E-01

B: 0.204165E-02

C: 0.323701E-02

D: −0.503488E-03

Coefficients of the eighth aspherical surface are given by:

K: 1.004006

A: −0.324197E-01

B: 0.977356E-02

C: 0.546480E-03

D: −0.574010E-04

Coefficients of the ninth aspherical surface are given by:

K: −4.146636

A: −0.388063E-01

B: 0.756998E-02

C: −0.778179E-03

D: 0.291100E-04

Coefficients of the tenth aspherical surface are given by:

K: −7.849828

A: −0.114627E-01

B: 0.528338E-03

C: −0.114828E-04

D: −0.630073E-06

In the second embodiment, a TL of an optical system is 9.75 mm, a distortion is less than 0.5% as illustrated in FIG. 5C, and a resolution under 100 cycle/mm is more than 40% as illustrated in FIG. 6.

### SECOND COMPARISON EXAMPLE

Following table 4 represents a second comparison example for the second embodiment of the present invention.

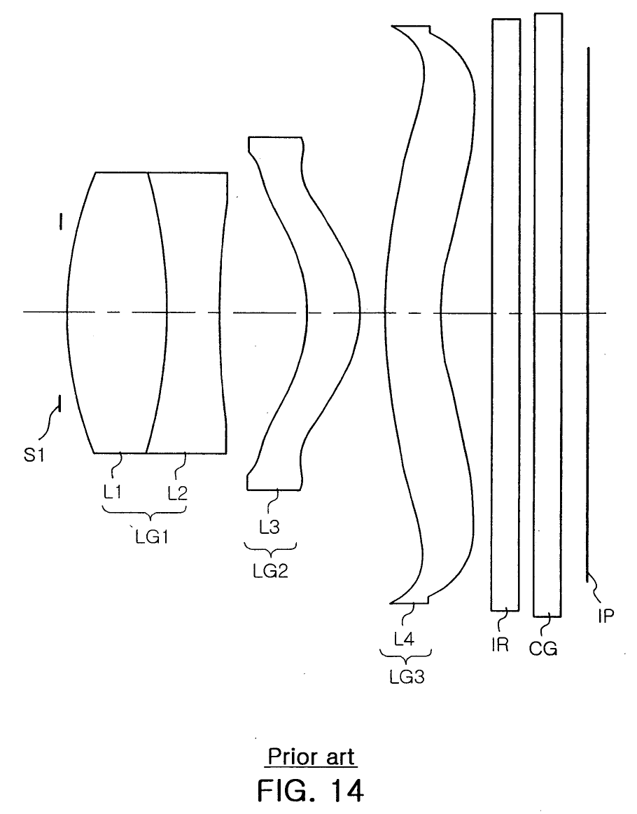

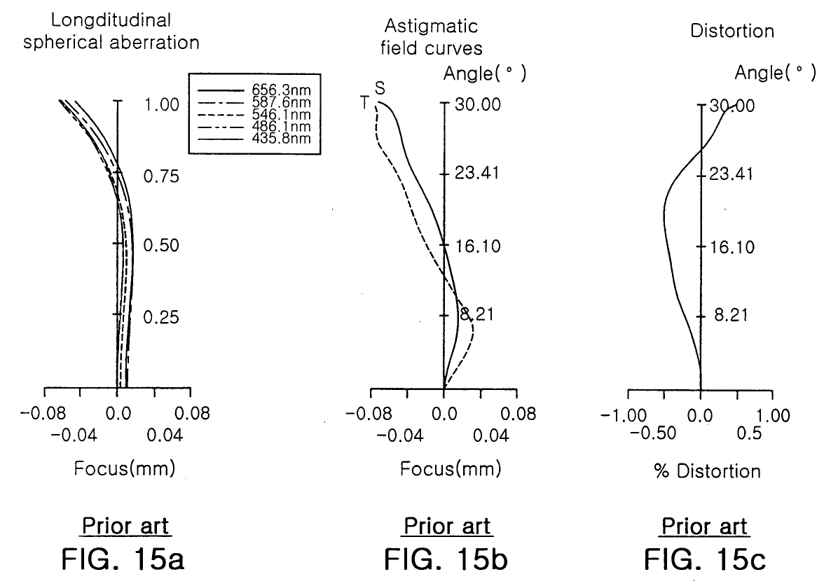

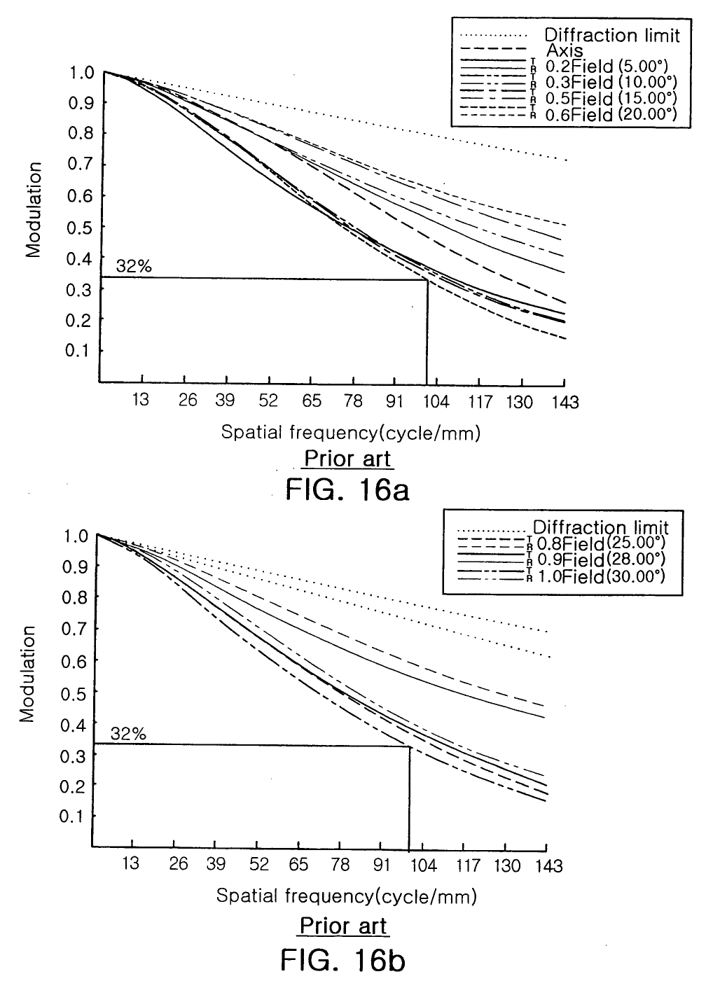

FIG. 14 is a view illustrating a lens construction of an optical system using a diffraction lattice according to the second comparison example, FIGS. 15A through 15C are graphs explaining aberrations of an optical system shown in table 4 and FIG. 14, and FIG. 16 is a graph illustrating MTF characteristics of the second comparison example.

For comparison with the second embodiment, F number is 2.8, an incident angle is 200 or less, and an image height is 4.4 mm in the second comparison example.

TABLE 4

| | | Thickness | | | |
|---|---|---|---|---|---|
| | Radius of | or | Index of | Abbe | |
| | curvature | distance | refraction | number | |
| Plane No. | (R) | (t) | (Nd) | (vd) | Remark |
| S1 | ∞ | 0.1000 | — | — | Aperture |
| | | | | | stop |
| 1 | 4.7755 | 1.9000 | 1.8042 | 46.5 | 1st lens |
| | | | | | group |
| 2 | −7.1785 | 0.7000 | 1.8052 | 25.5 | |
| 3 | 10.3197 | 2.0000 | — | — | |
| *4 | −2.1883 | 0.9127 | 1.53 | 56 | 2nd lens |
| | | | | | group |
| *5 | −1.6631 | 0.2204 | — | — | |
| *6 | 5.8632 | 1.4000 | 1.53 | 56 | 3rd lens |
| | | | | | group |
| *7 | 23.5284 | 1.0214 | — | — | |
| 8 | ∞ | 0.5000 | 1.5168 | 64.2 | IR |
| | | | | | filter |
| 9 | ∞ | 0.3580 | — | — | |
| 10 | ∞ | 0.5000 | 1.5168 | 64.2 | Cover |
| | | | | | glass |
| 11 | ∞ | 0.4500 | — | — | |
| 12 | ∞ | 0.0000 | — | — | Image |
| | | | | | Plane |

In table 4, * represents an aspherical surface and aspherical coefficients by the equation 1 are given as follows. Here, a fourth surface (object side of the third lens), a fifth surface (image side of the third lens), a sixth surface (object side of the fourth lens), and a seventh surface (image side of the fourth lens) are aspherical.

Coefficients of the fourth aspherical surface are given by:

K: −1.280423

A: −0.106001E-01

B: 0.746599E-03

C: 0.127681E-02

D: −0.152189E-03

Coefficients of the fifth aspherical surface are given by:

K: −0.876473

A: 0.148617E-01

B: −0.288037E-02

C: 0.136726E-02

D: −0.104532E-03

Coefficients of the sixth aspherical surface are given by:

K: −31.599354

A: 0.212124E-02

B: −0.142453E-03

C: 0.630843E-05

D: −0.399351E-06

Coefficients of the seventh aspherical surface are given by:

K: −9.007339

A: −0.630543E-02

B: 0.458655E-03

C: −0.183027E-04

D: −0.330755E-08

In the second comparison example, a TL of an optical system is 10.31 mm, a distortion is less than 0.5% as illustrated in FIG. 15C, and a resolution under 100 cycle/mm is more than 30% as illustrated in FIG. 3.

Comparison of the second embodiment with the second comparison example shows that the second embodiment has the smaller TL and thus small sizing and slim profiling of an optical system are possible and also has a better resolution on the MTF curve.

### Third Embodiment

The following table 5 represents numerical examples according to a third embodiment of the present invention.

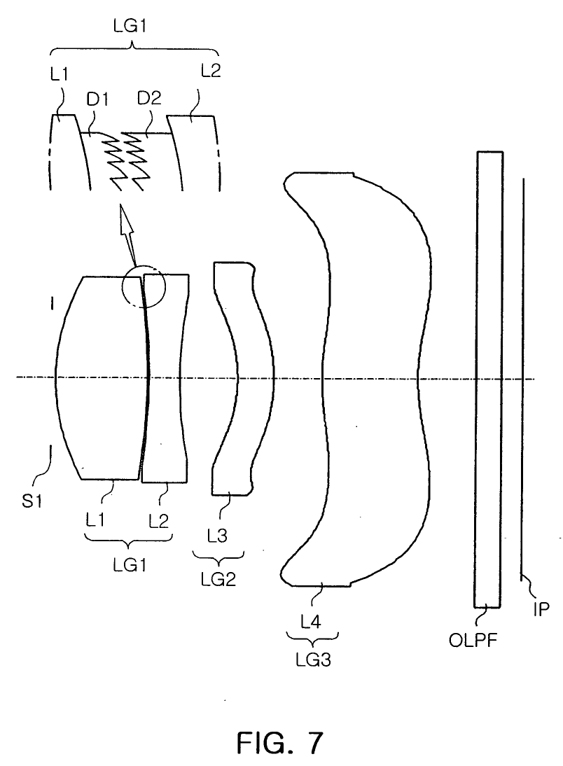

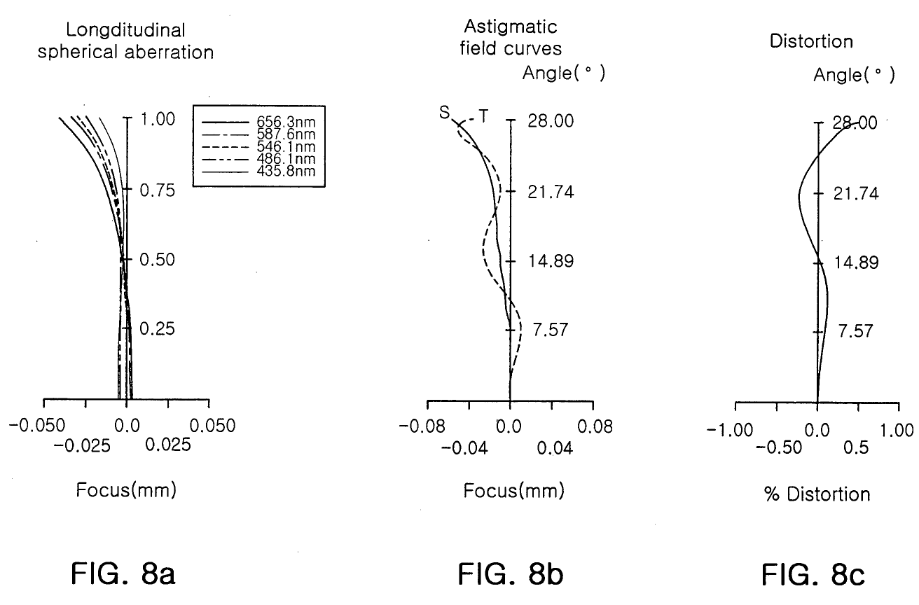

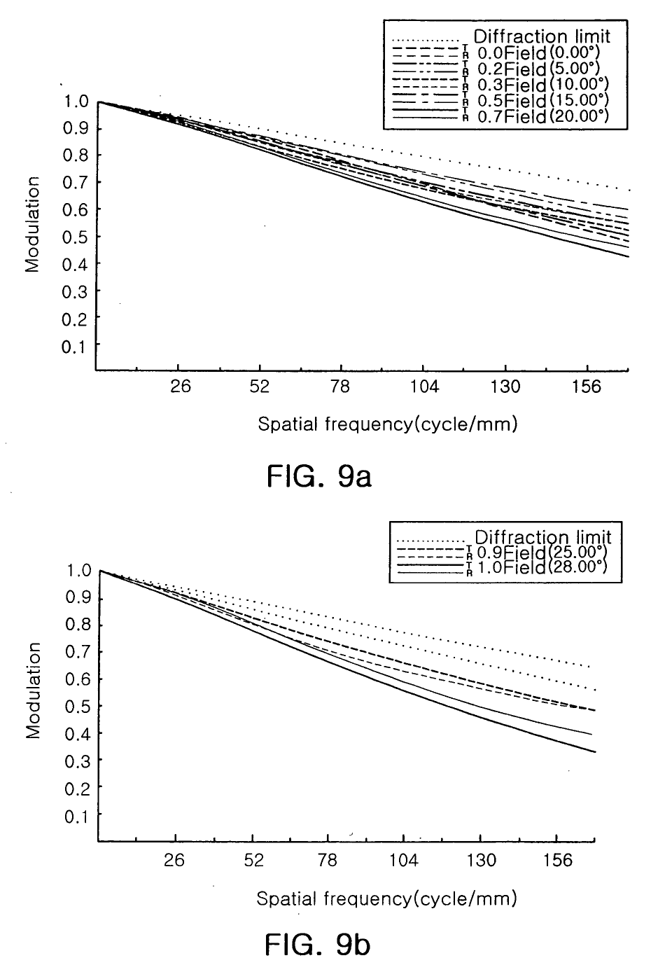

FIG. 7 is a view illustrating a lens construction of an optical system using a diffraction lattice according to a third embodiment of the present invention, FIGS. 8A through 8C are graphs explaining aberrations of an optical system shown in table 5 and FIG. 7, and FIG. 9 is a graph illustrating MTF characteristics of the third embodiment.

In the third embodiment, F number is 2.8, an incident angle is 20° or less.

TABLE 5

| | | Thickness | | | |
|---|---|---|---|---|---|
| | Radius of | or | Index of | Abbe | |
| | curvature | distance | refraction | number | |
| Plane No. | (R) | (t) | (Nd) | (vd) | Remark |
| S1 | ∞ | 0.1000 | — | — | Aperture |
| | | | | | stop |
| 1 | 4.1681 | 1.7432 | 1.8042 | 46.5 | 1st lens |
| | | | | | group |
| 2 | −9.9176 | 0.0100 | 1.49 | 58 | 1st DOE |
| 3 | −9.9176 | 0.0020 | — | — | |
| (diffraction | | | | | |
| plane) | | | | | |
| 4 | −9.9176 | 0.0150 | 1.49 | 58 | 2nd DOE |
| (diffraction | | | | | |
| plane) | | | | | |
| 5 | −9.9176 | 0.4712 | 1.8052 | 25.5 | |
| 6 | 9.0028 | 1.3902 | — | — | |
| *7 | −2.8549 | 0.7593 | 1.53 | 56 | 2nd lens |
| | | | | | group |
| *8 | −3.3501 | 0.6718 | — | — | |
| *9 | 5.2399 | 2.1900 | 1.53 | 56 | 3rd lens |
| | | | | | group |
| *10 | 4.8254 | 0.8411 | — | — | |
| 11 | ∞ | 0.4994 | 1.5168 | 64.2 | IR |
| | | | | | filter |
| 12 | ∞ | 0.2535 | — | — | |
| 13 | ∞ | 0.4994 | 1.5168 | 64.2 | Cover |
| | | | | | glass |
| 14 | ∞ | 0.3043 | — | — | |
| 15 | ∞ | 0.0000 | — | — | Image |
| | | | | | plane |

In table 5, * represents an aspherical surface and aspherical coefficients by the equation 1 are given as follows. Here, a seventh surface (object side of the third lens), an eighth surface (image side of the third lens), a ninth surface (object side of the fourth lens), and a tenth surface (image side of the fourth lens) are aspherical.

Coefficients of the seventh aspherical surface are given by:

K: −0.191571

A: −0.170882E-01

B: 0.204165E-02

C: 0.323701E-02

D: −0.503488E-03

Coefficients of the eighth aspherical surface are given by:

K: 1.004006

A: −0.324197E-01

B: 0.977356E-02

C: 0.546480E-03

D: −0.574010E-04

Coefficients of the ninth aspherical surface are given by:

K: −4.146636

A: −0.388063E-01

B: 0.756998E-02

C: −0.778179E-03

D: 0.291100E-04

Coefficients of the tenth aspherical surface are given by:

K: −7.849828

A: −0.114627E-01

B: 0.528338E-03

C: −0.114828E-04

D: −0.630073E-06

Also in the third embodiment, a distortion is less than 0.5% as illustrated in FIG. 8C, and a resolution of more than 45% under 130 cycle/mm can be obtained as illustrated in FIG. 6.

As described above, the present invention has an advantage that a chromatic aberration correction performance is improved in comparison with the conventional doublet lens.

Further, the number of concentric circles of the DOE is reduced, whereby the DOE can be easily manufactured.

According to the present invention, small sizing of an optical system can be achieved and the MTF characteristics is improved, so that performances improvements of an optical system such as realization of a high resolution can be achieved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. an optical system using DOEs (diffraction optical elements) comprising:
an aperture stop for controlling light amount;
a first lens group, a second lens group, and a third lens group arranged sequentially from an object side, the first lens group including a first lens having plus refractive power and a second lens having minus refractive power arranged sequentially from the object side, and the second and the third lens groups having a lens, at least one refraction surface of which is aspherical;
a first DOE joined to an image side of the first lens; and
a second DOE joined to an object side of the second lens in correspondence to the first DOE.

2. The system of claim 1, wherein the first DOE has dentations of a vertical symmetry on its cross section of an optical axis, the dentations are so configured as to form a plurality of concentric circles around the optical axis, a shape of the second DOE is so formed as to be engaged with that of the first DOE, and the concentric circles get small in their pitch when they are positioned on outer sides of the first and the second DOEs.

3. The system of claim 1, wherein the first and the second DOEs are formed with optical material having the same abbe number.

4. The system of claim 3, wherein the optical material is PMMA(polymethyl methacrylate)

5. The system of claim 1, wherein a first DOE's thickness on an optical axis is smaller than a second DOE's thickness on an optical axis.

6. The system of claim 1, wherein an interval between the first and the second DOEs is smaller than a thickness of the first DOE so that diffraction flare light generated from the first DOE is incident to the second DOE before the diffraction flare light is diffused.
